(19) United States
(12) Patent Application Publication
(10) Pub. No.: US 2008/0035178 A1
(43) Pub. Date: Feb. 14, 2008

(54) Process for cleaning passages in workpieces, and associated apparatus

(76) Inventors: Rene Jabado, Berlin (DE); Jens Dahl Jensen, Berlin (DE); Ursus Kruger, Berlin (DE); Daniel Kortvelyessy, Berlin (DE); Volkmar Luthen, Berlin (DE); Ralph Reiche, Berlin (DE); Michael Rindler, Schoneiche (DE); Raymond Ullrich, Schonwalde (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/717,801

(22) Filed: Mar. 13, 2007

(30) Foreign Application Priority Data
Mar. 13, 2006 (EP) 06005105.9

(51) Int. Cl. B08B 9/032

(52) U.S. Cl. 134/22.16; 134/169 R; 134/22.18

(57) ABSTRACT

The invention relates to a process for cleaning passages in workpieces, in particular cooling-air passages in turbine components, such as transition pieces or turbine blades or vanes, wherein the workpiece having the passages is immersed in a liquid bath and a liquid is suddenly forced under pressure through the passages.

The invention relates to a process for cleaning passages in workpieces, in particular cooling-air passages in turbine components, such as transition pieces or turbine blades or vanes. It also relates to an apparatus for carrying out this process.

Turbine components intended for gas turbines are, for example, air-cooled, in particular if the gas turbine is operated at high temperatures. For this purpose, cooling air is introduced, for example through cavities in turbine components. The cooling air then emerges at certain points on the hot gas surface, via cooling-air passages. Examples of turbine components of this type include turbine blades or vanes, as disclosed for example in DE 692 10 892 T2, DE 36 42 798 A1 and DE 694 20 582 T2.

During operation or repair, cooling passages of this type become contaminated or even blocked by foreign substances or oxidation. This impedes the emergence of cooling air, leading to a deterioration in the cooling action. This can lead to failure of the turbine component.

To avoid this, during the repair of turbine components, the cooling passages are cleaned and/or any blockages are removed. In the prior art, this involves the use of mechanical tools or a laser. This often presents difficulty on account of the hardness of the contaminants, their condition and also the angular position of the bores. Laser processes are complex on account of the laser positioning and also fail if the contaminant is transparent, as is the case for example with glass shot peening residues.

The invention is based on the object of providing a process which makes it easy to effectively clean passages at workpieces, in particular cooling-air passages at transition pieces. A second part of the object consists in designing a suitable apparatus.

According to the invention, the first part of the object is achieved by virtue of the fact that the workpiece having the passages is immersed in a liquid bath and a liquid is suddenly forced under pressure through the passages. Therefore, the basic concept of the invention is allowing an incompressible medium in the form of a liquid to act on the cooling passages, suddenly, i.e. within a short time and with a high force, thereby loosening contaminants. In this way, any blocked passages are opened and any contaminated passages regain their original geometry.

It is advantageous for an apparatus to be inserted into the liquid bath, which apparatus has a housing with a cavity that has an outlet opening on one side, wherein the cavity in the housing is filled with liquid and the outlet opening of the housing is placed onto the workpiece at the location where there is at least one cooling passage, and wherein liquid is suddenly displaced out of the cavity and is forced into the passage or passages via the outlet opening. The apparatus need not necessarily be aligned with the cooling passages. On account of the incompressible nature of the liquid, its pressure force is direction-independent, which means that its effect manifests itself even if the discharge from the outlet opening is not directed toward the passage that is to be cleaned. This makes the cleaning fast and effective.

In a refinement of the invention, the workpiece is immersed in the liquid bath sufficiently far for the cavity to be situated entirely below the level of the liquid when the apparatus has been placed onto the workpiece. This ensures that the cavity is completely filled with the liquid.

The invention also proposes that the liquid in the cavity is displaced in the direction of the outlet opening. The displacement can be effected with the aid of a displacement body which can move within the cavity, is externally actuated and can be driven into the cavity for example with the aid of a hammer. Alternatively, the displacement body can be mechanically actuated or motor-actuated. This is especially favorable if a large number of passages are to be cleaned. It is also possible for the liquid to be suddenly placed under pressure manually or mechanically in an external apparatus. In this case, the liquid is forced into the passages via a feed line.

In particular if a large number of cooling-air passages are to be cleaned, it is advantageous to use a separate attachment apparatus which is placed onto the turbine blade or vane in the region of the passages and is then supplied via a feed line with the liquid, which has been placed under pressure in an external apparatus. In this way, a large number of passages can be cleaned in a single operation.

A particularly suitable liquid is water, since it is noncombustible and also presents no danger to health. However, it is also possible to use a fused salt or a liquid phase of a chemical element.

According to the invention, the second part of the object is achieved by an apparatus which has a housing with a cavity which on one side has an outlet opening, wherein a displacement body, which has an actuating element projecting out of the housing, is guided movably into the cavity, so that the displacement body can be acted on from the outside in order for liquid to be forced out of the outlet opening. An apparatus of this type is distinguished by a simple design and therefore by its affordability and simple handling.

A refinement of the apparatus according to the invention proposes that the cavity is in the form of a hollow cylinder with a cylinder wall, and that the displacement body is configured as a displacement piston guided by the cylinder wall. A particularly good displacement effect is achieved in this way. The actuating element may in this case be in the form of a piston rod which adjoins the displacement piston on the side remote from the outlet opening and is expediently guided in the housing.

The invention also proposes that the housing has at least one passage opening on that side of the body which is remote from the outlet opening, so that when the displacement body is actuated air or liquid can flow into the space behind the displacement piston, which means that a vacuum cannot form therein.

The invention also proposes that the housing has an adapter in which the outlet opening is located. At its outer surface, the adapter can be matched to the surface shape of the particular workpiece to be cleaned, in such a way that it bears against the workpiece such that it surrounds the outlet opening. This substantially prevents the liquid forced out of the outlet opening from escaping, with the result that the force emanating from the displacement body is converted as completely as possible into pressure force within the liquid. The adapter can, for example, be screwed to the housing, so that it is easy to exchange for other adapters.

In addition, it is expedient if the outlet opening is surrounded by a seal, which when an adapter is fitted is arranged in said adapter. The seal may, for example, be an O-ring, which ensures an optimum sealing action when the apparatus is placed onto the workpiece.

Finally, according to the invention the apparatus has a restoring spring which holds the displacement body in a starting position, so that the action of force on the displacement body takes place counter to the resistance of the restoring spring. It is expedient for the spring to be arranged in the cavity, where it is protected.

The drawing illustrates the invention in more detail on the basis of an exemplary embodiment. In the drawing:

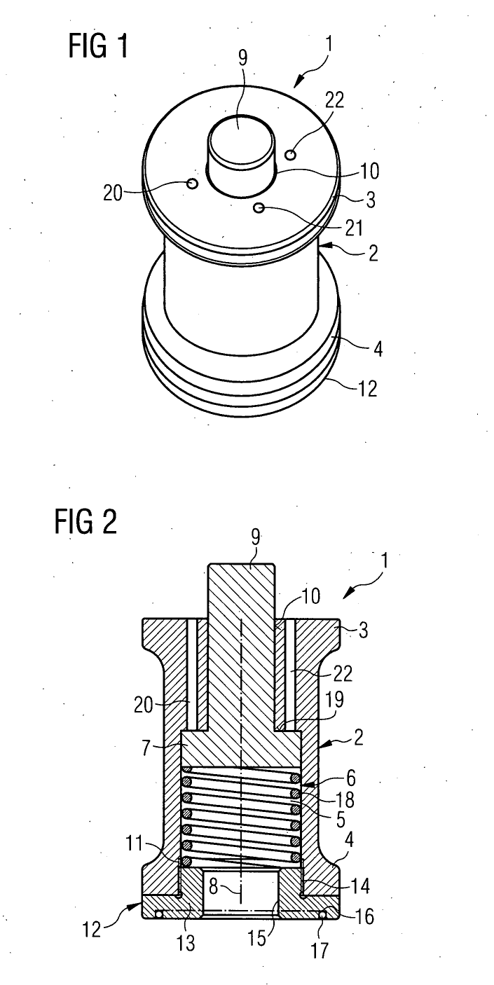

FIG. 1 shows a perspective view of the apparatus according to the invention, obliquely from above,

FIG. 2 shows a cross section through the apparatus shown in FIG. 1,

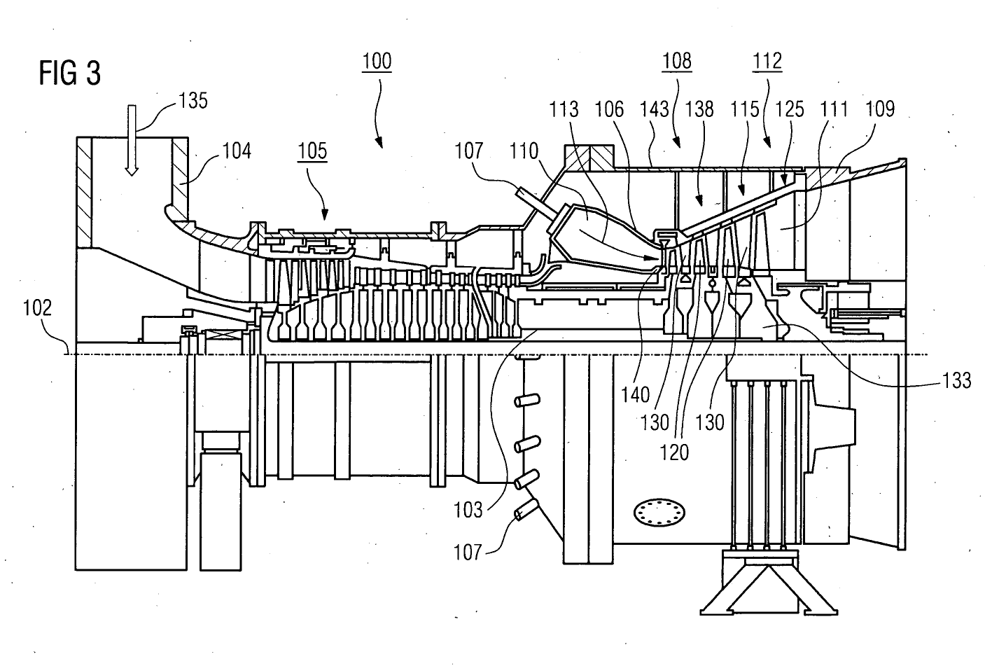

FIG. 3 shows a gas turbine,

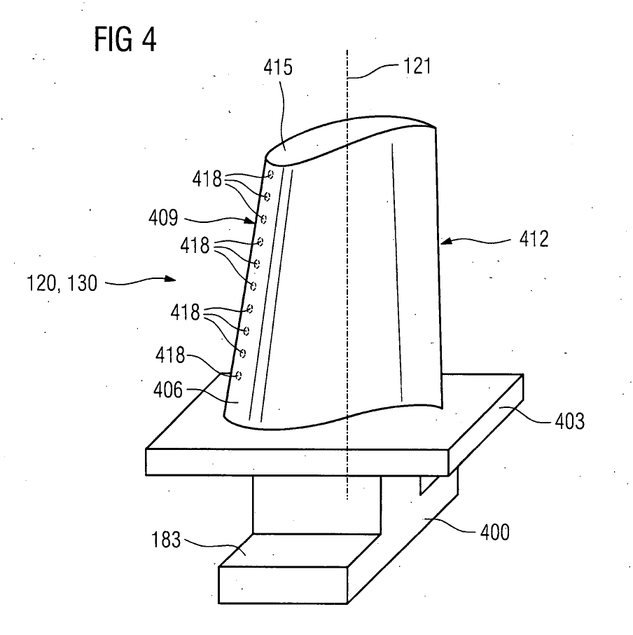

FIG. 4 shows a perspective view of a turbine blade or vane, and

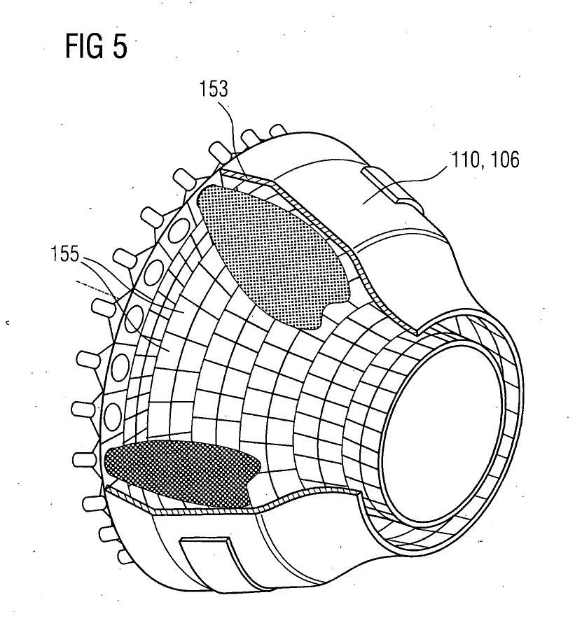

FIG. 5 shows a perspective view of a combustion chamber.

The apparatus 1 illustrated in the figures has a substantially cylindrical housing 2 which is delimited at the top and bottom by an annular web 3, 4 in each case. Inside the housing 2 there is a cylindrical cavity 5 which is surrounded by a cylinder wall 6. A displacement piston 7 is guided in the cavity 5 in such a manner that it can move axially in the direction of the center axis 8 of the housing 2, with its periphery bearing against the cylinder wall 6. The displacement piston 7 continues at the top in a piston rod 9 which projects to the outside, where it has a blunt end. The piston rod 9 is guided in a cylindrical bore 10 in the housing 2.

In the lower region, the cylinder wall 6 of the cavity 5 has an internal screw thread 11, into which an adapter disk 12 is screwed. For this purpose, the adapter disk 12 has a collar 13 which projects into the cavity 5 and is provided with an external screw thread 14. The adapter disk 12 has a cylindrical outlet opening 15 via which the cavity 5 is connected to the outside.

The adapter disk 12 is planar on its underside, where it has an annular groove 16, into which an elastomeric sealing ring 17, which projects outward slightly, is fitted.

A coil spring 18 in the form of a compression spring is clamped between the underside of the displacement piston 7 and the collar 13 of the adapter disk 12. It ensures that the displacement piston 7 is pressed onto a shoulder 19 of the housing 2, thereby adopting its starting position. Venting passages 20, 21, 22, which are open to the outside, open out into the shoulder 19. They ensure that in the event of the displacement piston 7 moving toward the outlet opening 15, a vacuum is not formed at the rear side of the displacement piston 7, which would impede this movement.

To clean and open up passages 418 (FIG. 4) in a workpiece 120, 130 (FIG. 4), 155 (FIG. 5), first of all the workpiece is completely immersed in a water bath, so that the passages and any cavities inside the workpiece are filled with the water. Thereafter, the free side of the adapter disk 12 of the apparatus 1 is placed onto the component, specifically at a location where the openings of passages, in particular of cooling-air passages, are located. Workpieces and apparatus 1 are immersed in the water bath to a sufficient extent for even the cavity 5 to be completely filled with water. After the apparatus 1 has been placed onto the workpiece, the sealing ring 17 ensures that the outlet opening 15 is sealed with respect to the workpiece.

The apparatus 1 is then manually held in the desired position. Thereafter, the top end of the piston rod 9 is struck, for example, with a rubber mallet. As a result, the piston rod 9 is driven into the housing 2, with the result that the displacement piston 7 forces water located in the cavity 5 out of the outlet opening 15. The high pressure which is briefly generated opens up blocked passages and removes contaminants in the passages. After it has been struck with the mallet, the displacement piston 7 is moved back into its starting position shown by the action of the coil spring 18, so that the apparatus 1 is ready for the operation to be repeated or for a new cleaning operation to be carried out at a different location.

FIG. 3 shows, by way of example, a partial longitudinal section through a gas turbine 100.

In the interior, the gas turbine 100 has a rotor 103 which is mounted such that it can rotate about an axis of rotation 102, has a shaft 101, and is also referred to as the turbine rotor.

An intake housing 104, a compressor 105, a, for example, toroidal combustion chamber 110, in particular an annular combustion chamber 110, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 110, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon, scandium (Sc) and/or at least one rare earth element or hafnium). Alloys of this type are known from EP 0 486 489 B1, EP 0 786 017 B1, EP 0 412 397 B1 or EP 1 306 454 A1, which are intended to form part of the present disclosure with regard to the chemical composition of the alloys.

A thermal barrier coating, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 4 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation (MCrAlX; M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy; The density is preferably 95% of the theoretical density.

A protective aluminum oxide layer (TGO=thermal grown oxide layer) is formed on the MCrAlX layer (as an interlayer or as the outermost layer).

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have porous grains or grains which are provided with microcracks or macrocracks in order to improve the resistance to thermal shocks. It is preferable for the thermal barrier coating to be more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of a gas turbine. The combustion chamber 110, is configured, for example, as what is known as an annular combustion chamber, in which a multiplicity of burners 107 which produce flames 156 and are arranged circumferentially around the axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co,), nickel (Ni), X is an active element and stands for yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

It is also possible for a, for example, ceramic thermal barrier coating, consisting for example of ZrO₂, Y₂O₃—ZrO₂, i.e. unstabilized, partially stabilized or fully stabilized by yttrium oxide and/or calcium oxide and/or magnesium oxide, to be present on the MCrAlX.

Columnar grains are produced in the thermal barrier coating by means of suitable coating processes, such as for example electron beam physical vapor deposition (EB-PVD).

Other coating processes are conceivable, for example atmospheric plasma spraying (APS), LPPS, VPS or CVD. The thermal barrier coating may have porous grains or grains which are provided with microcracks or macrocracks in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, on account of the high temperatures in the interior of the combustion chamber 110, a cooling system may be provided for the heat shield elements 155 and/or for their holding elements. The heat shield elements 155 are in this case, for example, hollow and may also have cooling holes (not shown) opening out into the combustion chamber space 154.

1.-21. (canceled)

22. A process for cleaning cooling-air passages in turbine components, comprising:
immersing a workpiece containing a plurality of cooling air passages in a liquid bath;
inserting a hollow apparatus into the liquid bath, wherein the apparatus has:
a housing that defines a cavity, and
an outlet opening arranged on a side of the housing,
filling the apparatus cavity with the liquid;
arranging the outlet opening of the apparatus onto the workpiece such that the opening is aligned with a cooling air passage; and
forcing the liquid under pressure through the cooling air passages to effectuate cleaning of the passages.

23. The process as claimed in claim 22, wherein the workpiece is immersed sufficiently far in the liquid bath for the cavity to be situated entirely below the surface of the liquid after the apparatus has been placed onto the workpiece.

24. The process as claimed in claim 23, wherein the liquid in the cavity is displaced in the direction of the outlet opening.

25. The process as claimed in claim 24, wherein the fluid is displaced by a displacement body that moves within the cavity and is externally actuated.0

26. The process as claimed in claim 25, wherein the displacement body is mechanically actuated or motor-actuated.

27. The process as claimed in claim 22, wherein the liquid is placed under pressure suddenly in an external apparatus.

28. The process as claimed in claim 27, wherein the pressure in the external apparatus is generated mechanically.

29. The process as claimed in one of claim 28, wherein the liquid is selected from the group consisting of water, a fused salt, and a liquid phase of a chemical element.

30. An apparatus for cleaning passages in a workpiece, comprising:
a housing having a cavity;
an outlet arranged on a side of the housing; and
a displacement body movably arranged in the cavity, the displacement body having an actuating element projecting out of the housing, wherein the housing has a passage opening on a side of the displacement body remote from the outlet opening.

31. The apparatus as claimed in claim 30, wherein the cavity is a hollow cylinder shape having a cylinder wall, and
the displacement body is a displacement piston guided by the cylinder wall.

32. The apparatus as claimed in claim 31, wherein the actuating element is a piston rod that adjoins the displacement piston on a side remote from the outlet opening.

33. The apparatus as claimed in claim 32, wherein the piston rod is guided in the housing.

34. The apparatus as claimed in claim 30, wherein the housing has an adapter located at the outlet opening.

35. The apparatus as claimed in claim 34, wherein the adapter is be exchangeably secured to the housing.

36. The apparatus as claimed in claim 35, wherein the adapter is screwed to the housing.

37. The apparatus as claimed in claim 30, wherein the outlet opening is surrounded by a seal.

38. The apparatus as claimed in claim 34, wherein the seal is arranged in the adapter.

39. The apparatus as claimed in claim 30, wherein the apparatus has a restoring spring which holds the displacement body in a starting position.

40. The apparatus as claimed in claim 39, wherein the restoring spring is arranged in the cavity.

41. A device for cleaning cooling air passages in a turbine components, comprising:
a hollow cylindrical housing configured to contain a liquid;
an outlet opening arranged at an end of the cylindrical housing; and
a piston arranged in the cavity having an actuating element extending out of the housing in a direction opposite the outlet opening, wherein the housing has a passage opening opposite the outlet opening.
